(19) United States
(12) Patent Application Publication
(10) Pub. No.: US 2012/0113510 A1
(43) Pub. Date: May 10, 2012

(54) DISPLAY DEVICE AND DISPLAY METHOD

(75) Inventor: Yoshihisa Sato, Saitama (JP)

(73) Assignee: Sony Corporation, Tokyo (JP)

(21) Appl. No.: 13/288,344

(22) Filed: Nov. 3, 2011

(30) Foreign Application Priority Data
Nov. 10, 2010 (JP) 2010-252241

(51) Int. Cl. G02B 27/22

(52) U.S. Cl. 359/462

(57) ABSTRACT

A display device includes: a display unit sequentially displaying q-pieces (“q” is an integer of 2 or more) of display patterns respectively including p-pieces (“p” is an integer of 2 or more) of viewpoint pictures arranged cyclically in one screen and having parallax therebetween; an optical separation device optically separating the p-pieces of viewpoint pictures respectively included in the q-pieces of display patterns displayed on the display unit, wherein the display unit is configured so that plural sub-pixels are two-dimensionally arranged in units of r-types (“r” is an integer of 3 or more) of colors necessary for color picture display, and one unit pixel is composed of r-pieces of sub-pixels having colors different from one another selected from the plural display patterns in respective viewpoint pictures.

### FIELD

The present disclosure relates to a 3D display device and a 3D display method capable of performing 3D display by a parallax barrier system.

### BACKGROUND

A display device (3D display device) realizing stereoscopic display attracts attention in recent years. In the 3D display, a left-eye picture and a right-eye picture having parallax therebetween (having different viewpoints) are displayed and these pictures are respectively viewed by an observer by left and right eyes to thereby be recognized as a stereoscopic picture with depth. A display device capable of presenting more natural 3D pictures to the observer by displaying three or more pictures with parallax among them has been also developed.

The above 3D display device is roughly divided into a device with the need for dedicated glasses and a device without the need for them. The device without the need for dedicated glasses (that is, the one realizing stereoscopic viewing with naked eye.) is desirable as the dedicated glasses make the observer feel troublesome. As 3D display devices realizing stereoscopic viewing with naked eyes, for example, 3D display devices using a parallax barrier system and a lenticular lens system are known. In the 3D display device in these systems, plural pictures (viewpoint pictures) having parallax therebetween are displayed at the same time, and pictures to be seen are different according to relative positional relationship (angles) between the display device and the viewpoints of the observer. When pictures with plural viewpoints are displayed in such 3D display device, there is problem that substantial resolution of pictures will be resolution obtained by dividing resolution of the display device itself such as a CRT (Cathod Ray Tube) or a liquid crystal display device by the number of viewpoints, which reduces picture quality.

In response to these problems, various studies have been made. For example, in JP-A-2009-104105, there is proposed a method of improving resolution equivalently by switching a transmitting state and a blocking state of respective barriers in a time sharing manner in the parallax barrier system to perform time-sharing display.

As a technique for achieving balance between resolution in a horizontal direction of a screen and in a vertical direction of a screen, a step-barrier system has been developed. In the step-barrier system, an aligning direction (or an extending direction) of openings of a parallax barrier, or the axial direction of the lenticular lenses is set to an oblique direction of the screen, and sub-pixels of plural colors (for example, R, G and B) aligned in the oblique direction compose one unit pixel.

### SUMMARY

However, in the step-barrier system, sub-pixels R, G and B included in one unit pixel 104 in a certain viewpoint picture are aligned in the oblique direction as in a liquid crystal display panel 102 shown in FIG. 19. Therefore, a plane area allocated to one unit pixel 104 in the display screen is increased, which may hinder high definition picture display. Also in the case where the time-sharing driving is performed in Patent Document 1, the above problem in the step-barrier system can arise.

In view of the above, it is desirable to provide a 3D display device and a 3D display method capable of improving reduction of resolution occurring in the 3D display by the parallax barrier system.

An embodiment of the present disclosure is directed to a display device including a display unit sequentially displaying q-pieces (“q” is an integer of 2 or more) of display patterns respectively including p-pieces (“p” is an integer of 2 or more) of viewpoint pictures arranged cyclically in one screen and having parallax therebetween and an optical separation device optically separating the p-pieces of viewpoint pictures respectively included in the q-pieces of display patterns displayed on the display unit so as to realize stereoscopic viewing at p-pieces of viewpoints. The display unit is configured so that plural sub-pixels are two-dimensionally arranged in units of r-types (“r” is an integer of 3 or more) of colors necessary for color picture display, and one unit pixel is composed of r-pieces of sub-pixels having colors different from one another selected from the plural display patterns in respective viewpoint pictures. The optical separation device is, for example, a variable parallax barrier including plural light transmitting portions through which light from the display unit or light toward the display unit is transmitted and plural light shielding portions shielding light from the display unit or light toward the display unit, which is configured so that an arrangement state of these plural light transmitting portions and plural light shielding portions can be switched corresponding to the q-pieces of display patterns.

Another embodiment of the present disclosure is directed to a display device including a display unit sequentially displaying p-pieces (“p” is an integer of 2 or more) of viewpoint pictures in q-pieces (“q” is an integer of 2 or more) of display patterns respectively including plural arrangements of sub-pixels and an optical separation device optically separating the p-pieces of viewpoint pictures. Here, one unit pixel is composed of the plural sub-pixels selected from the plural display patterns in the respective viewpoint pictures.

Still another embodiment of the present disclosure is directed to a display method including sequentially displaying q-pieces (“q” is an integer of 2 or more) of display patterns on a display unit, which respectively includes p-pieces (“p” is an integer of 2 or more) of viewpoint pictures arranged cyclically in one screen and having parallax therebetween and optically separating the p-pieces of viewpoint pictures respectively included in the q-pieces of display patterns displayed on the display unit by using an optical separation device. Here, the display unit configured so that plural sub-pixels are two-dimensionally arranged in units of r-types (“r” is an integer of 3 or more) of colors necessary for color picture display is used, and one unit pixel is composed of r-pieces of sub-pixels having colors different from one another selected from the plural display patterns in respective viewpoint pictures.

In the display device and the display method according to the embodiments of the present disclosure, the plural sub-pixels constituting one unit pixel are selected from plural display patterns (frames) sequentially displayed in the temporally different timing. Accordingly, one unit pixel is formed by combination of plural sub-pixels arranged closer to each other in the screen of the (two-dimensional) display unit. That is, the occupied area allocated to one unit pixel on the screen can be reduced.

In the display device and the display method according to the embodiments of the present disclosure, the unit pixel in respective viewpoint pictures is formed by combination of sub-pixels selected from plural display patterns which are respectively displayed in a time-sharing manner. As a result, the occupied area allocated to one unit pixel on the screen can be reduced, which can improve resolution. For example, when sub-pixels of different colors are arranged in an oblique direction in respective display patterns, high-definition 3D pictures can be displayed while achieving balance between resolution in the vertical direction of the screen and resolution in the horizontal direction of the screen.

### BRIEF DESCRIPTION OF THE DRAWINGS

FIG. 1 is a configuration diagram showing a configuration of a 3D display device according to a first embodiment of the present disclosure;

FIG. 2 is a block diagram showing circuits concerning display control in the 3D display device according to the first embodiment;

FIG. 3 is a plan view showing sub-pixel arrangement of a liquid crystal display panel in the 3D display device according to the first embodiment;

FIGS. 4A and 4B are plan views showing an example of a first and second display patterns displayed on the liquid crystal display panel shown in FIG. 1 and so on;

FIGS. 5A and 5B are plan views showing an example of a first and second barrier patterns formed on a switch liquid crystal panel shown in FIG. 1 and so on;

FIGS. 6A and 6B are explanatory views schematically showing a state of stereoscopic viewing in first and second display periods;

FIGS. 7A and 7B are plan views showing arrangement patterns of sub-pixels viewed by a right eye and a left eye in the first display period;

FIGS. 8A and 8B are plan views showing arrangement patterns of sub-pixels viewed by the right eye and the left eye in the second display period;

FIG. 9 is a plan view showing a first composite picture recognized as a first viewpoint picture according to the first embodiment;

FIG. 10 is a plan view showing a second composite picture recognized as a second viewpoint picture according to the first embodiment;

FIG. 11 is a plan view showing a first modification example in the first composite picture shown in FIG. 9;

FIGS. 12A to 12C are plan views showing an example of first to third display patterns displayed on the liquid crystal display panel in a 3D display device according to a second embodiment of the present disclosure;

FIGS. 13A to 13C are plan views showing arrangement patterns of sub-pixels viewed by the right eye in the liquid crystal display panel of the 3D display device according to the second embodiment;

FIGS. 14A to 14C are plan views showing arrangement patterns of sub-pixels viewed by the left eye in the liquid crystal display panel of the 3D display device according to the second embodiment;

FIG. 15 is a plan view showing a first composite picture recognized as a first viewpoint picture according to the second embodiment;

FIG. 16 is a plan view showing a second composite picture recognized as a second viewpoint picture according to the second embodiment;

FIG. 17 is a configuration diagram showing a configuration of a 3D display device according to a modification example of the present disclosure;

FIG. 18 is a plan view showing a configuration of a switch liquid crystal panel in the 3D display device according to the modification example of the present disclosure; and

FIG. 19 is a plan view showing a unit pixel in a display pattern in a step-barrier system in related art.

### DETAILED DESCRIPTION

Hereinafter, best modes for carrying out the technology (hereinafter, referred to as embodiments) will be explained in detail with reference to the drawings. A 3D display method is embodied by a 3D display device, therefore, the method will be explained in conjunction with the embodiments of the device.

### First Embodiment

### [Structure of a 3D Display Device]

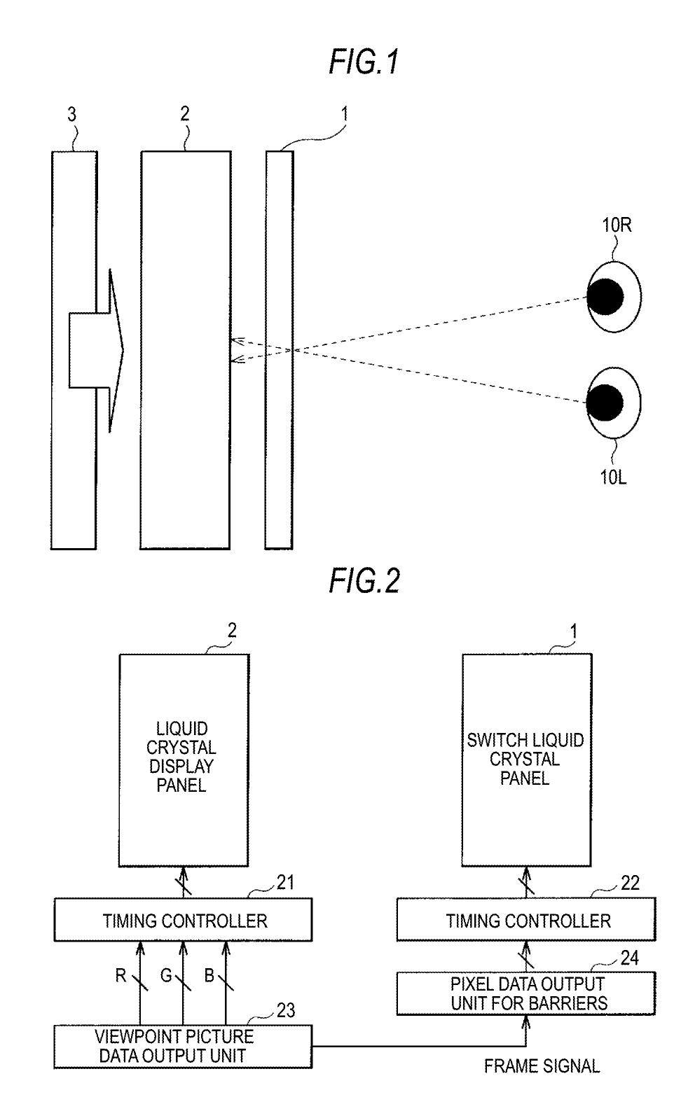

FIG. 1 shows the entire configuration of a 3D display device according to a first embodiment of the present disclosure. FIG. 2 shows circuits concerning display control of the 3D display device. The 3D display device includes a liquid crystal display panel 2, a backlight 3 arranged on a back surface side of the liquid crystal display panel 2 and a switch liquid crystal panel 1 arranged so as to face the display surface side of the liquid crystal display panel 2 as shown in FIG. 1. The 3D display device also includes a timing controller 21 for controlling display operation in the liquid crystal display panel 2 and a viewpoint picture data output unit 23 as shown in FIG. 2. The 3D display device further includes a timing controller 22 for controlling switching operation in the switch liquid crystal panel 1 and a pixel data output unit for barriers 24.

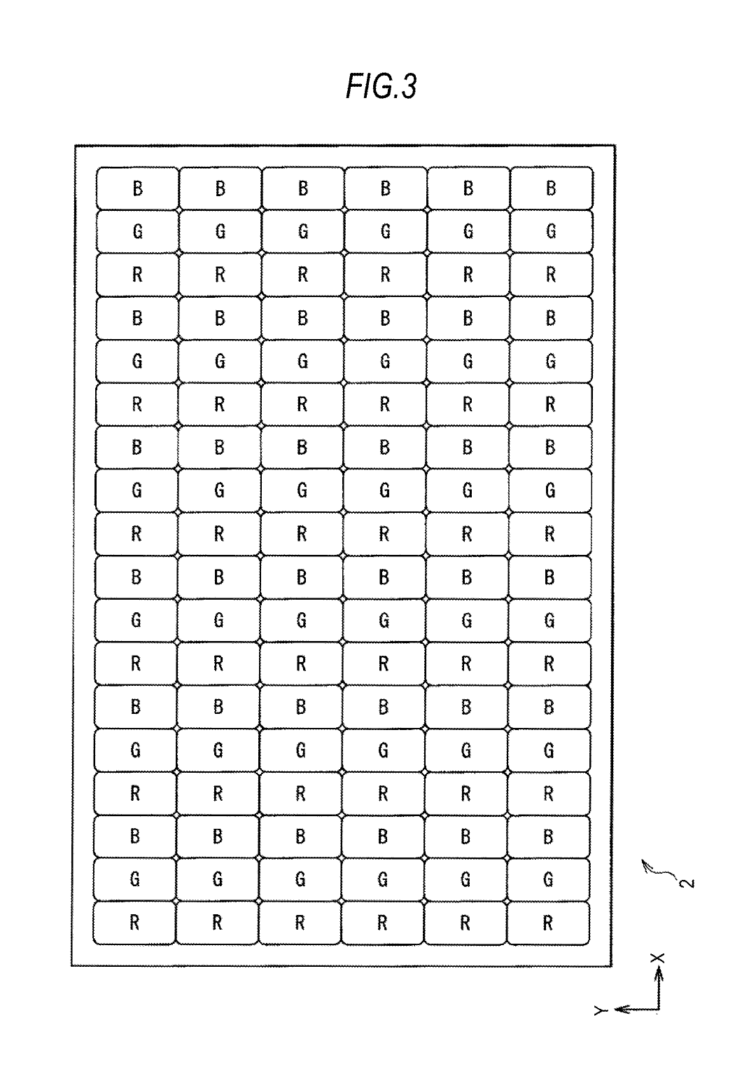

FIG. 3 shows an example of a pixel structure of the liquid crystal display panel 2. The liquid crystal display panel 2 has a pixel structure in which plural sub-pixels each having three colors of R (red), G (green) and B (blue) necessary for color display are arranged two-dimensionally. As shown in FIG. 3, sub-pixels of respective colors appear cyclically on the same row in the horizontal direction (X-axis direction) as well as sub-pixels of the same one color are arranged on the same column in the vertical direction (Y-axis direction). The liquid crystal display panel 2 displays pictures two-dimensionally by modulating light irradiated from the backlight 3 by respective sub-pixels in the above pixel structure. The liquid crystal display panel 2 performs display of parallax pictures for 3D display outputted from the viewpoint picture data output unit 23 based on control by the timing controller 21.

As it is necessary to allow a left eye 10L and a right eye 10R to see different viewpoint pictures for realizing stereoscopic viewing, at least two viewpoint pictures which are a right-eye picture and a left-eye picture are necessary. When using three or more viewpoint pictures are used, multi-viewpoint stereoscopic viewing can be realized. In the embodiment, a case where four viewpoint pictures (first to fourth viewpoint pictures) are formed (namely, the number of viewpoints is four) as well as two viewpoint pictures of them (first and second viewpoint pictures) are used for observation will be explained.

The liquid crystal display panel 2 sequentially shows two types of display patterns. The two types of display patterns are formed by four viewpoint pictures (first to fourth viewpoint pictures) respectively arranged cyclically in one screen and having parallax therebetween which are combined and displayed. That is, the liquid crystal display panel 2 periodically switches display positions of the four viewpoint pictures to two states by alternately displaying (time sharing display) two types of display patterns. Picture data corresponding to respective display patterns is outputted from the viewpoint picture data output unit 23. The timing when respective display patterns are displayed is controlled by the timing controller 21.

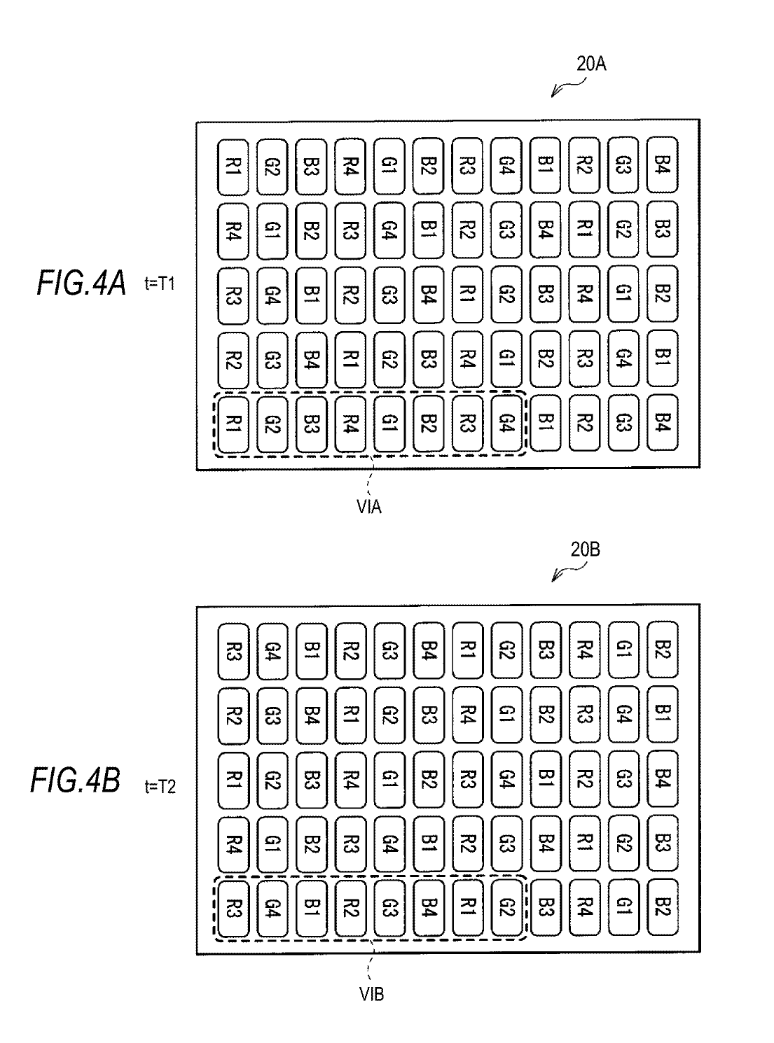

FIGS. 4A and 4B show display patterns 20A, 20B as an example of two types of display patterns to be displayed in the time-sharing manner. In FIGS. 4A and 4B, for example, a first sub-pixel row including sub-pixels to which signs R1, G2 and B1 are given, a second sub-pixel row including sub-pixels to which signs R2, G2 and B2 are given, a third sub-pixel row including sub-pixels to which signs R3, G3 and B3 are given and a fourth sub-pixel row including sub-pixels to which signs R4, G4 and B4 are given respectively extend in parallel in an oblique direction (direction intersecting both of the X-axis and the Y-axis in an XY-plane) and are arranged cyclically in the horizontal direction in the screen. The sub-pixels R1, G1 and B1 are components of unit pixels for displaying a first viewpoint picture (for example, a right-eye picture) and the sub-pixels R2, G2 and B2 are components of unit pixels for displaying a second viewpoint picture (for example, a left-eye picture). The sub-pixels R3, G3, B3 compose a third viewpoint picture and the sub-pixels R4, G4 and B4 compose a fourth viewpoint picture. As a result, the first to fourth viewpoint pictures in stripes extending in the oblique direction are cyclically arranged in the horizontal direction in one screen.

Positions of sub-pixels displaying the first to fourth viewpoint pictures are different from each other in the display pattern 20A of FIG. 4A and the display pattern 20B of FIG. 4B. For example, to the sub-pixels R1, G1 and B1 to which the first viewpoint picture is assigned in the display pattern 20A, the third viewpoint picture is assigned in the display pattern 20B, which are sub-pixels R3, G3 and B3. Similarly, to the sub-pixels to which the second, third or fourth viewpoint picture is assigned in the display pattern 20A, the fourth, first or second viewpoint picture is assigned in the display pattern 20B.

The switch liquid crystal panel 1 includes plural pixels arranged two-dimensionally, which can perform switching operation of switching between a light transmitting state and a non-light transmitting state in respective pixels. The switch liquid crystal panel 1 realizes a function as a variable parallax barrier. The switch liquid crystal panel 1 forms barrier patterns for optically separating respective parallax pictures displayed on the liquid crystal display panel 2 for realizing stereoscopic viewing. The switch liquid crystal panel 1 forms two types of barrier patterns respectively corresponding to the display patterns 20A, 20B shown in FIGS. 4A and 4B by periodically switching the patterns to two states.

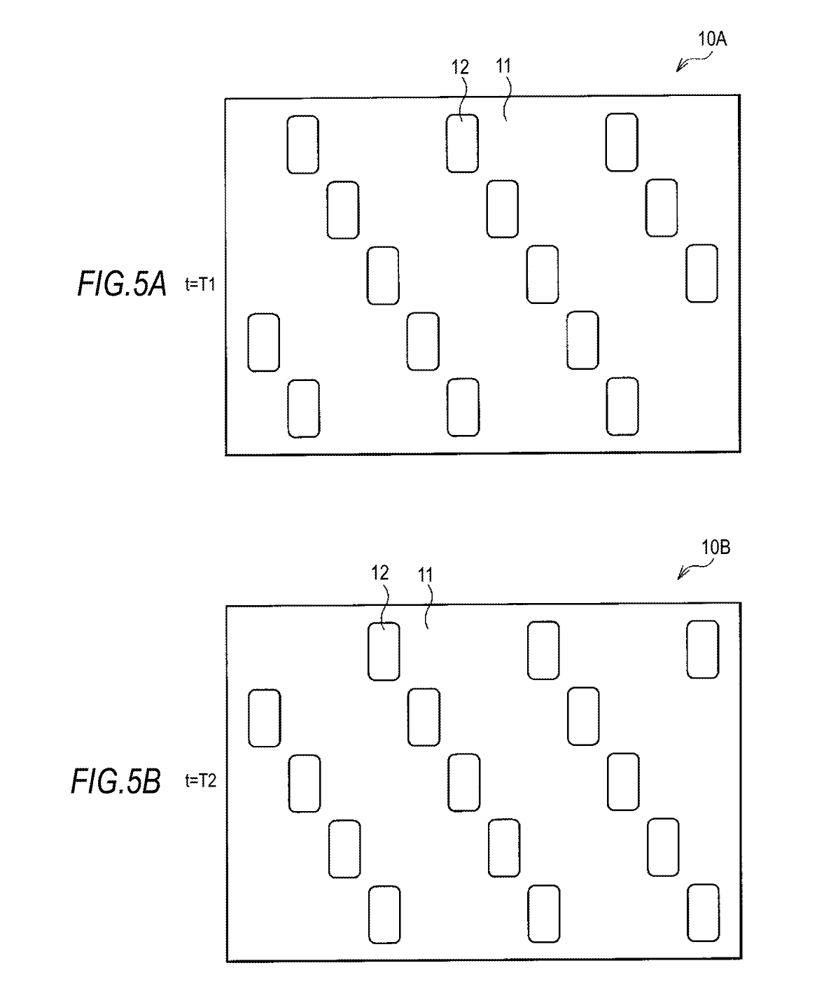

FIGS. 5A and 5B show examples of the two battier patterns (barrier patterns 10A, 10B). The barrier patterns 10A, 10B are both patterns including light shielding portions 11 shielding light of display pictures from the liquid crystal display panel 2 and openings 12 through which light of display pictures are transmitted. FIG. 5A shows the barrier pattern 10A corresponding to the display pattern 20A of FIG. 4A, and FIG. 5B shows the barrier pattern 10B corresponding to the display pattern 20B of FIG. 4B. That is, the barrier pattern 10A optically separates light of display pictures for realizing stereoscopic viewing when respective viewpoint pictures are displayed in the display pattern 20A. On the other hand, the barrier pattern 10B optically separates light of display pictures for realizing stereoscopic viewing when respective viewpoint pictures are displayed in the display pattern 20B. Arrangement positions and the shape of the openings 12 in the barrier patterns 10A, 10B are set so that light of different viewpoint pictures is separately incident on the left and right eyes 10L, 10R of the observer when the observer sees the 3D display device from a given position and a given direction.

Pixel data for forming the barrier patterns 10A, 10B in the switch liquid crystal panel 1 is outputted from the pixel data output unit for barriers 24. The timing when respective barrier patterns are formed in the switch liquid crystal panel (timing when switching between a state where light from respective sub-pixels is transmitted and a state where light is not transmitted) is controlled by the timing controller 22. The picture data of respective display patterns displayed in the liquid crystal display panel 2 is outputted from the viewpoint picture data output unit 23, and a frame signal obtained when respective display patterns are switched is outputted to the timing controller 22 through the pixel data output unit for barriers 24. The timing controller 22 performs controls so that switching timing of respective barrier patterns is synchronized with switching timing of respective display patterns in the liquid crystal display panel 2 based on the frame signal.

### [Operation of the 3D Display Device]

In the 3D display device, the display patterns 20A, 20B including four viewpoint pictures respectively arranged cyclically in one screen are periodically displayed in the time sharing manner in the liquid crystal display panel 2. That is, respective viewpoint pictures are displayed on the liquid crystal display panel 2 by being divided spatially as well as temporally. The barrier patterns 10A, 10B are formed so as to be synchronized with the switching of these display patterns 20A, 20B to realize stereoscopic viewing in the switch liquid crystal panel 1.

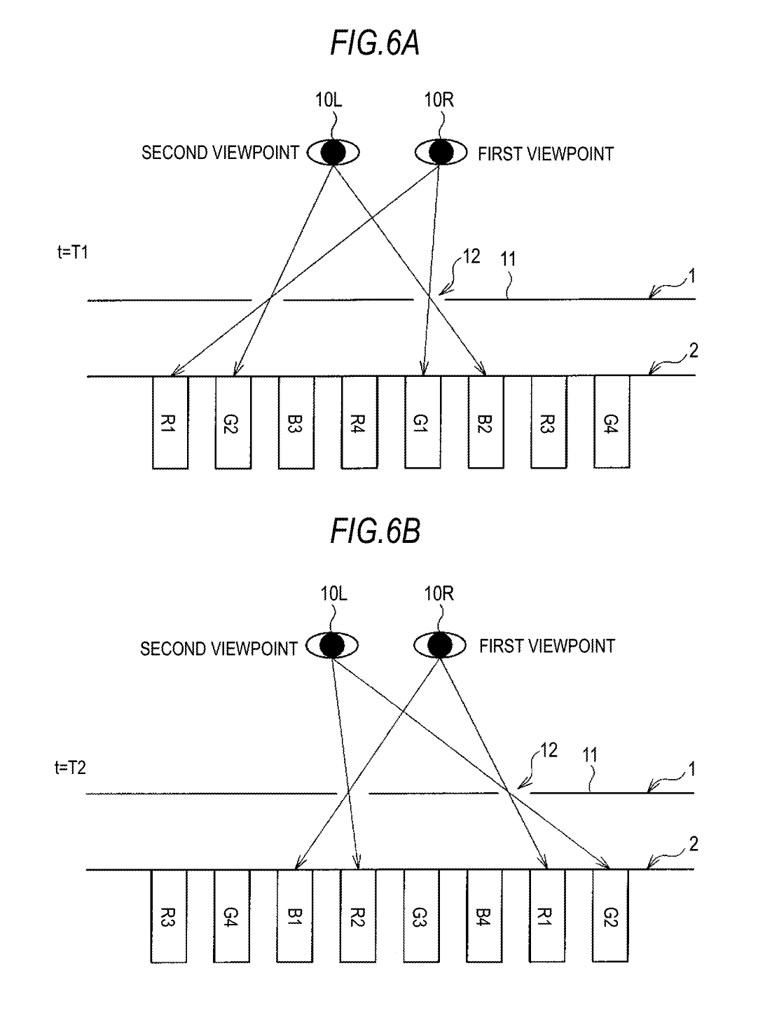

FIG. 6A schematically shows a state of stereoscopic viewing in the 3D display device in a first display period T1. FIG. 6B schematically shows a state of stereoscopic viewing in a second display period T2 which is different from the first display period T1. FIGS. 6A and 6B are conceptual diagrams indicating cross-sectional structures orthogonal to the screen (XY-plane) in an area VIA and an area VIB surrounded by dashed lines in FIG. 4A or FIG. 4B. It is desirable that the first and second display periods T1, T2 are 1/60 seconds or less (60 Hz or more). In the first display period T1, the display pattern 20A (FIG. 4A) is displayed on the liquid crystal display panel 2 as well as the barrier pattern 10A (FIG. 5A) is formed on the switch liquid crystal panel 1. On the other hand, in the second display period T2, the display pattern 20B (FIG. 4B) is displayed on the liquid crystal display panel 2 as well as the barrier pattern 10B (FIG. 5B) is formed on the switch liquid crystal panel 1.

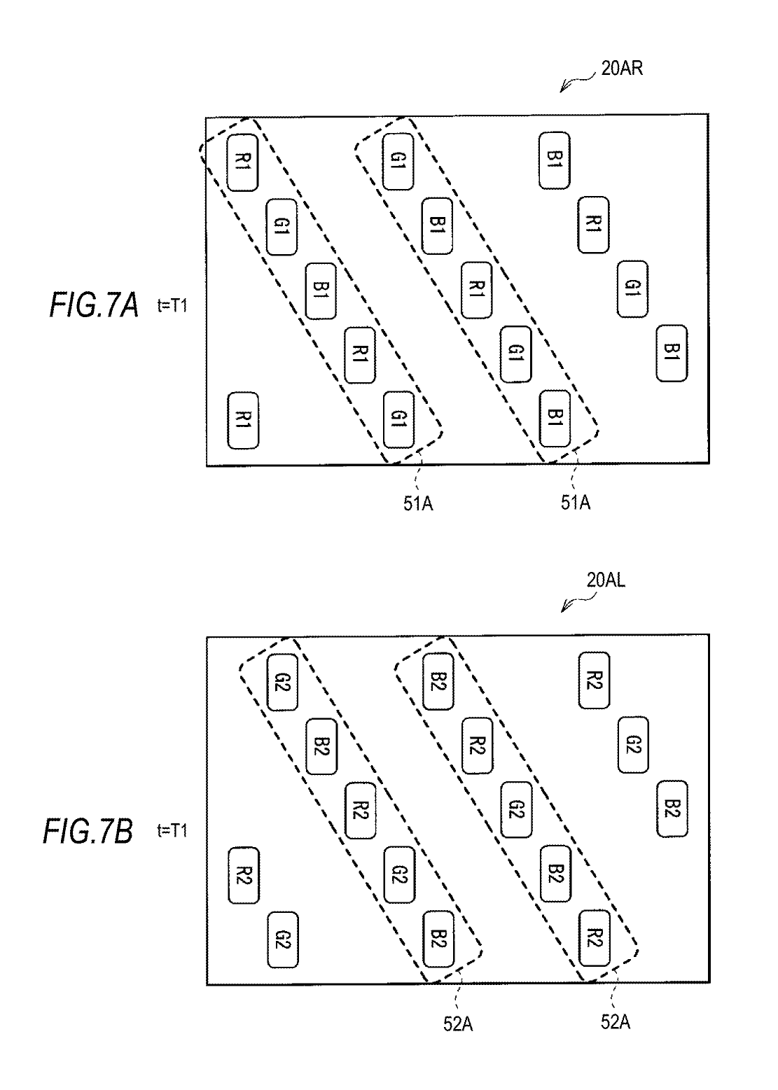

In FIGS. 6A and 6B, the right eye 10R of the observer is a first viewpoint and the left eye 10L is a second viewpoint. In the first display period T1, the first to fourth viewpoint pictures are displayed by sequentially being assigned to the sub-pixel row including sub-pixels R1, G1 and B1, the sub-pixel row including sub-pixels R2, G2, and B2, the sub-pixel row including sub-pixels R3, G3, and B3 and the sub-pixel row including sub-pixels R4, G4 and B4 in accordance with the display pattern 20A (FIG. 4A) on the liquid crystal display panel 2. Such display is observed through the barrier pattern 10A (FIG. 5A) formed by the switch liquid crystal panel 1. As a result, only light from the sub-pixels R1, G1 and B1 composing the first viewpoint picture is recognized by the right eye 10R as shown in FIG. 6A. FIG. 7A shows an arrangement pattern 20AR of sub-pixels viewed by the right eye 10R in the first display period T1. In the arrangement pattern 20AR, plural sub-pixel rows 51A including sub-pixels R1, G1 and B1 are arranged in a given cycle. On the other hand, only light from the sub-pixels R2, G2 and B2 composing the second viewpoint picture is recognized by the left eye 10L. FIG. 7B shows an arrangement pattern 20AL of sub-pixels viewed by the left eye 20L in the first display period T1. In the arrangement patter 20AL, plural sub-pixel rows 52A including sub-pixels R2, G2 and B2 are arranged in a given cycle. As a result, a stereoscopic image based on the first viewpoint picture and the second viewpoint picture is perceived in the first display period T1.

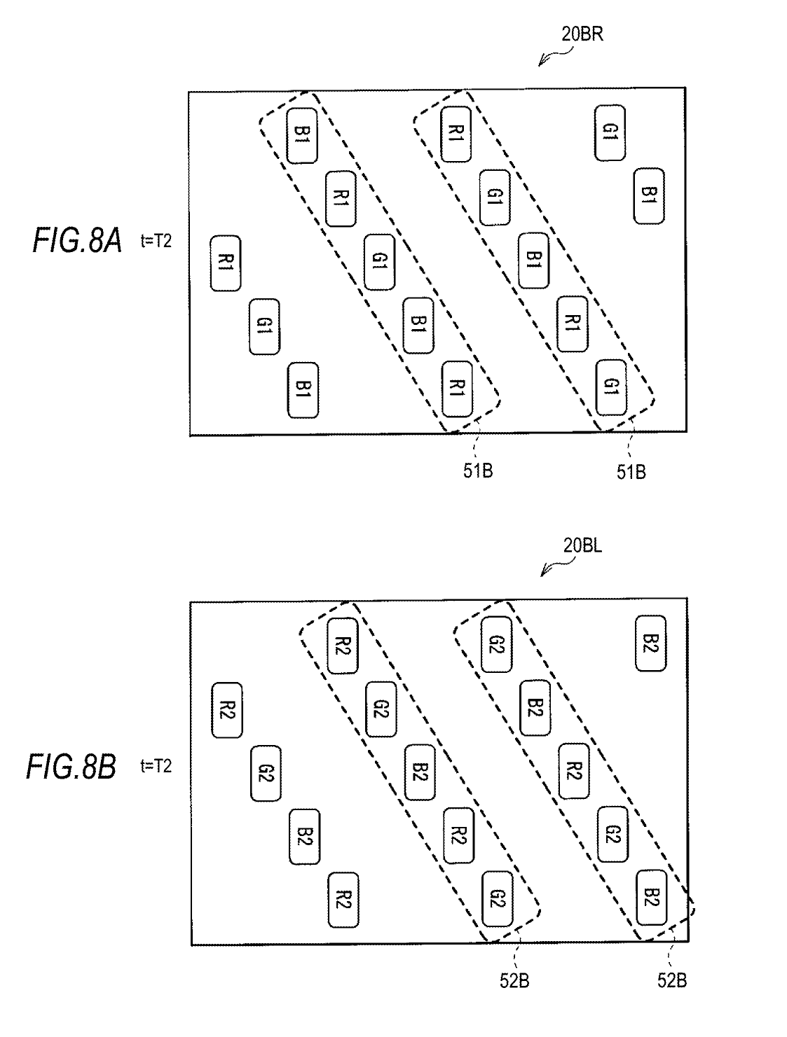

Moreover, in the second display period T2 continued from the first display period T1, the first to fourth viewpoint pictures are displayed by sequentially being assigned to the sub-pixel row including sub-pixels R1, G1 and B1, the sub-pixel row including sub-pixels R2, G2, and B2, the sub-pixel row including sub-pixels R3, G3, and B3 and the sub-pixel row including sub-pixels R4, G4 and B4 in accordance with the display pattern 20B (FIG. 4B) on the liquid crystal display panel 2. Such display is observed through the barrier pattern 10B (FIG. 5B) formed by the switch liquid crystal panel 1. As a result, only light from the sub-pixels R1, G1 and B1 composing the first viewpoint picture is recognized by the right eye 10R as shown in FIG. 6B. FIG. 8A shows an arrangement pattern 20BR of sub-pixels viewed by the right eye 10R in the second display period T2. In the arrangement pattern 20BR, plural sub-pixel rows 51B including sub-pixels R1, G1 and B1 are arranged in a given cycle. On the other hand, only light from the sub-pixels R2, G2 and B2 composing the second viewpoint picture is recognized by the left eye 10L. FIG. 8B shows an arrangement pattern 20BL of sub-pixels viewed by the left eye 10L in the second display period T2. In the arrangement patter 20BL, plural sub-pixel rows 52B including sub-pixels R2, G2 and B2 are arranged in a given cycle. As a result, a 3D image based on the first viewpoint picture and the second viewpoint picture is also perceived in the second display period T2.

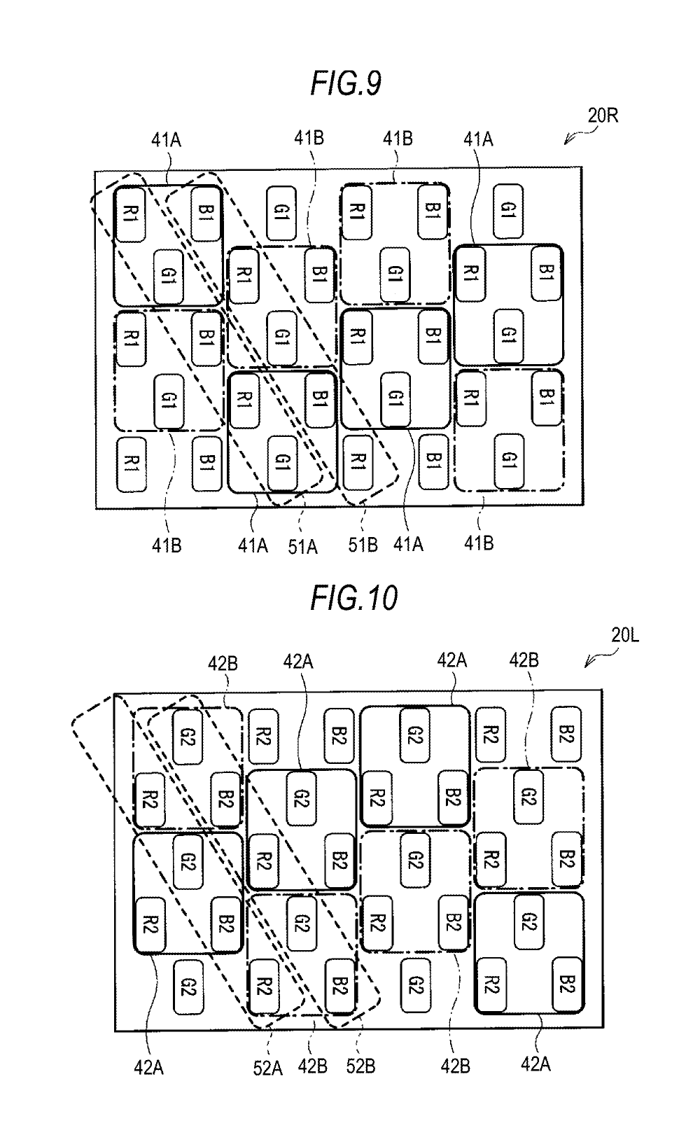

Here, the first and second display periods T1, T2 are extremely short periods of time. Therefore, the arrangement pattern 20AR shown in FIG. 7A and the arrangement pattern 20BR shown in FIG. 8A are recognized by the right eye 10R of the observer as an overlapped one picture. That is, a composite picture 20R obtained by combining the arrangement pattern 20AR with the arrangement pattern 20BR is recognized by the observer as the first viewpoint picture obtained from the right eye 10R as shown in FIG. 9. Similarly, a composite picture 20L obtained by combining the arrangement pattern 20AL shown in FIG. 7B with the arrangement pattern 20BL shown in FIG. 8B is recognized as the second viewpoint picture obtained from the left eye 10L as shown in FIG. 10. As a result, a 3D image based on the composite picture 20R (FIG. 9) as the first viewpoint picture and the composite picture 20L (FIG. 10) as the second viewpoint picture is perceived.

In this case, in the first and second viewpoint pictures, one unit pixel is formed by combination of sub-pixels of three colors selected from both of the two display patterns 20A, 20B. For example, two types of unit pixels 41A, 41B exist together in the composite picture 20R shown in FIG. 9. The unit pixel 41A is formed by combination of sub-pixels R1, G1 included in the sub-pixel row 51A of the display patterns 20A and the sub-pixel B1 included in the sub-pixel row 51B of the display pattern 20B. In respond to this, the unit pixel 41B is formed by combination of the sub-pixel B1 included in the sub-pixel row 51A of the display pattern 20A and sub-pixels R1, G1 included in the sub-pixel row 51B of the display pattern 20B. On the other hand, two types of unit pixels 42A, 42B exist together also in the composite picture 20L shown in FIG. 10. The unit pixel 42A is formed by combination of sub-pixels G2, B2 included in the sub-pixel row 52A of the display pattern 20A and the sub-pixel R2 included in the sub-pixel row 52B of the display pattern 20B. The unit pixel 42B is formed by combination of the sub-pixel R2 included in the sub-pixel row 52A of the display pattern 20A and sub-pixels G2, B2 included in the sub-pixel row 52B of the display pattern 20B.

As described above, it is desirable that plural sub-pixels composing one unit pixel are arranged so that respective center points are positioned at apexes of a polygon. More specifically, sub-pixels of two colors (for example, the sub-pixel R and the sub-pixel B) in sub-pixels of three colors composing one unit pixel exist on the same row (first row) in the horizontal direction of the screen as well as the sub-pixel (the sub-pixel G) of the remaining one color exists in a row (second row) adjacent to the first row where the sub-pixels of two colors (the sub-pixel R and the sub-pixel B) exist. In the embodiment, the sub-pixels R, G and B composing one unit pixel are arranged so that respective center points are positioned at apexes of an acute triangle.

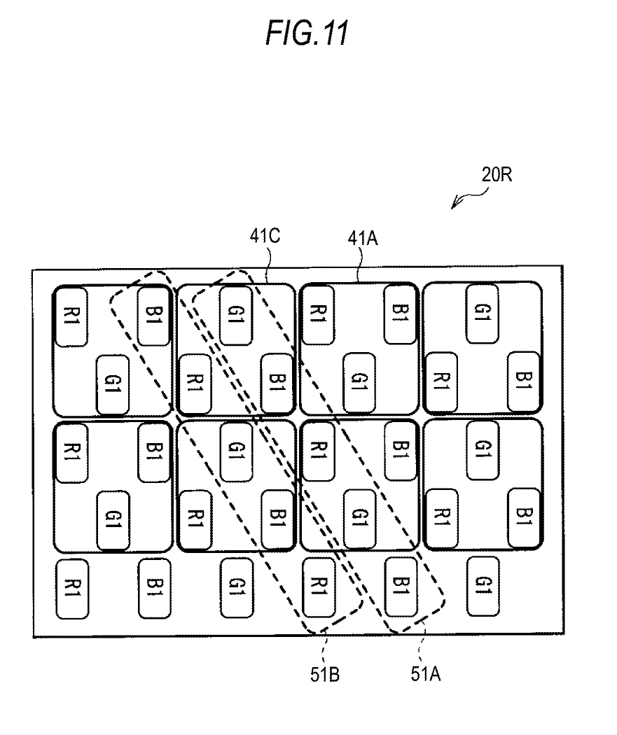

The combination of sub-pixels composing one unit pixel is not limited to ones shown in FIG. 9 and FIG. 10. For example, the composite picture 20R can include two types of unit pixels 41A, 41C as in a modification example shown in FIG. 11. Here, the unit pixel 41C is formed by combination of sub-pixels G1, B1 included in the sub-pixel row 51A of the display pattern 20A and the sub-pixel R1 included in the sub-pixel row 51B of the display pattern 20B. The same is applied to the composite picture 20L.

### Advantages of the First Embodiment

According to the embodiment described above, the unit pixel in the first and the second viewpoint pictures is formed by combination of plural sub-pixels selected from the display patterns 20A, 20B which are respectively displayed in the time-sharing manner. As a result, the occupied area allocated to one unit pixel on the screen can be reduced as compared with, for example, the step-barrier system in related art, which can improve resolution. In particular, one unit pixel is composed of three sub-pixels, which are sub-pixels of two colors (for example, the sub-pixel R and the sub-pixel B) positioned closest to each other in the first row in the sub-pixels of three colors and the sub-pixel of the remaining one color (the sub-pixel G) existing in the second row and positioned between these sub-pixels of two colors in the horizontal direction of the screen. According to the above arrangement, the occupied area allocated to one unit pixel on the screen can be further reduced and resolution can be further improved. Furthermore, the sub-pixels of different colors are arranged in the oblique direction in the display patterns 20A, 20B in the embodiment, therefore, high definition 3D pictures can be displayed while achieving balance between resolution in the vertical direction of the screen and resolution in the horizontal direction of the screen.

### Second Embodiment

Next, a 3D display device according to a second embodiment of the present disclosure will be explained. The same signs are given to components which are substantially the same as the 3D display device according to the first embodiment and explanation thereof will be appropriately omitted.

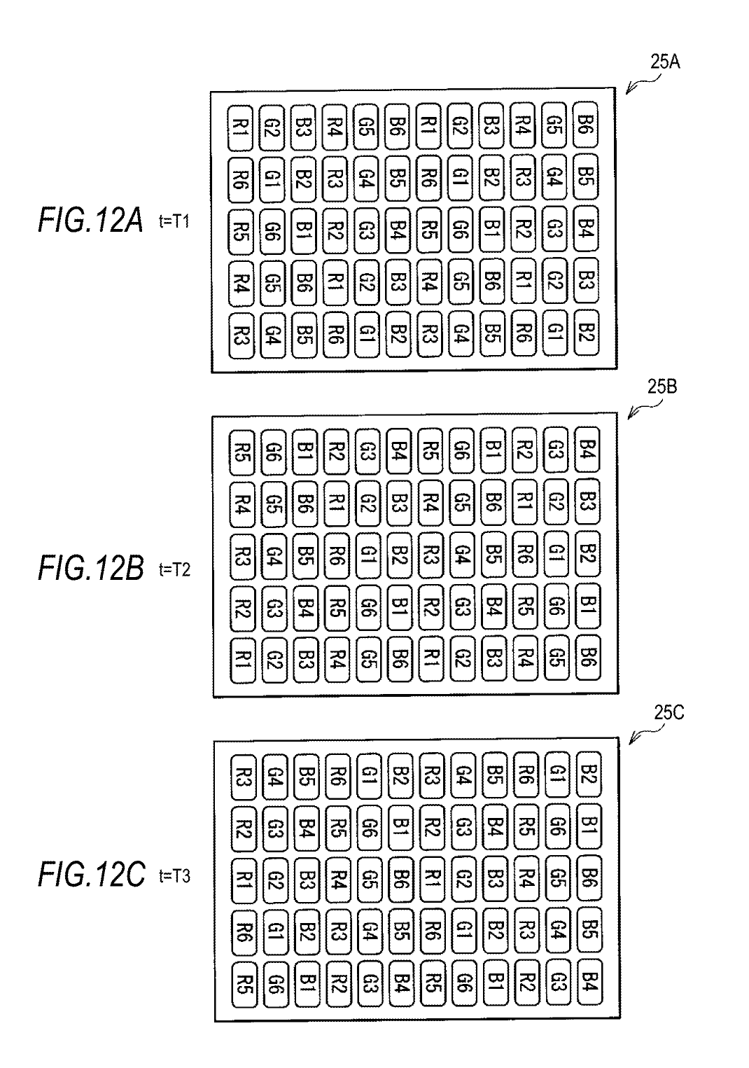

In the above first embodiment, the display positions of the first and second viewpoint pictures are periodically switched to two states by displaying two types of display patterns (display patterns 20A, 20B) alternately (time-sharing display) by the liquid crystal display panel 2. In the present embodiment, display positions of six viewpoint pictures (first to sixth viewpoint pictures) are periodically switched to three states by displaying three types of display patterns sequentially (time sharing display) by the liquid crystal display panel 2 as shown in FIGS. 12A to 12C. The three types of display patterns are sequentially displayed on the liquid crystal display panel 2 in a first display period T1, a second display period T2 and a third display period T3.

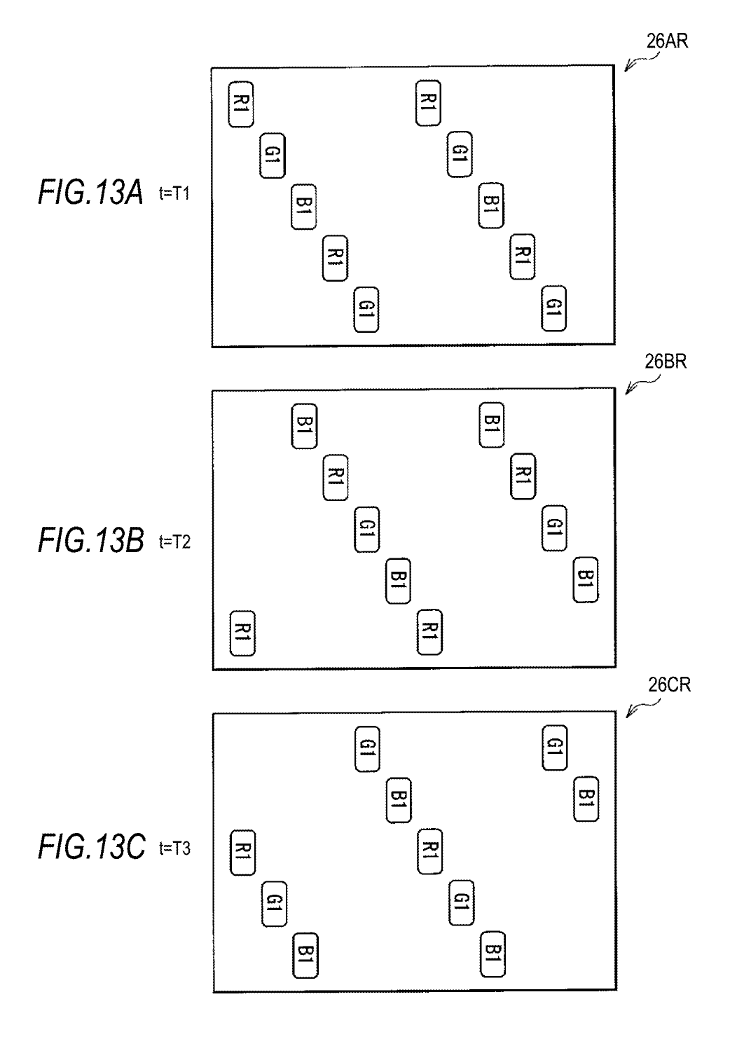

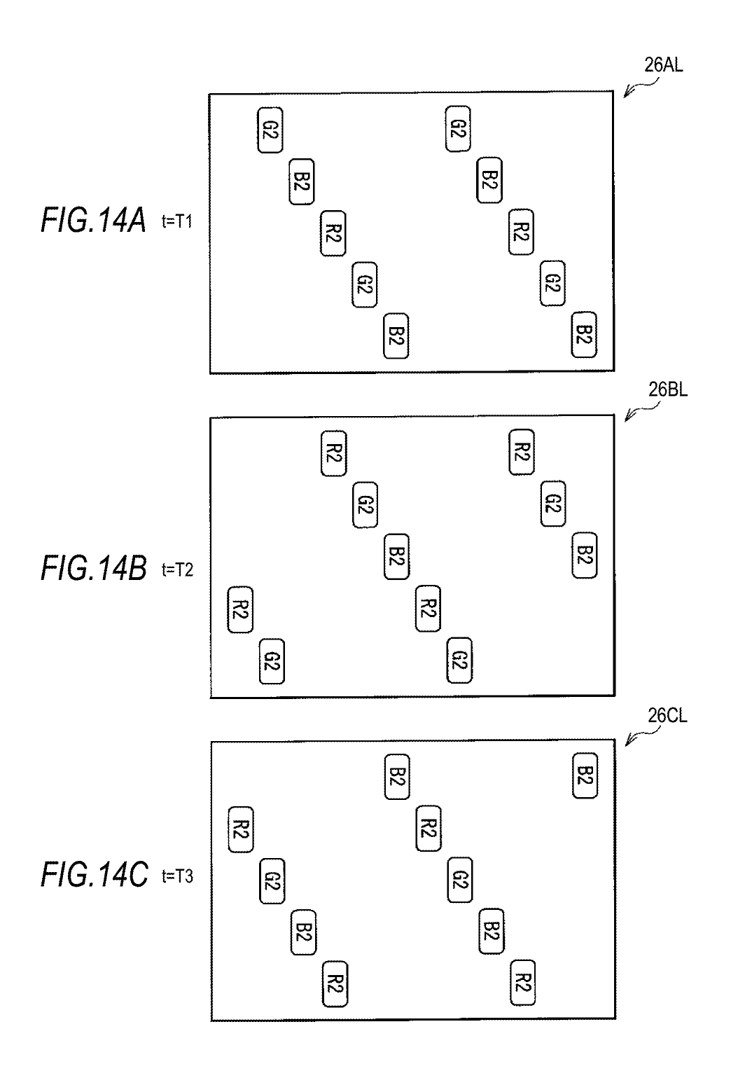

FIGS. 12A to 12C show three types of display patterns 25A, 25B and 25C displayed on the liquid crystal display panel 2 in the time-sharing manner. These display patterns 25A, 25B and 25C are observed through given barrier patterns (not shown) formed so as to correspond to respective patterns in the switch liquid crystal panel 1. As a result, an arrangement pattern 26AR shown in FIG. 13A is recognized in the first display period T1, an arrangement pattern 26BR shown in FIG. 13B is recognized in the second display period T2 and an arrangement pattern 26CR shown in FIG. 13C is recognized in the third display period T3 by the right eye 10R of the observer as the first viewpoint pictures. Similarly, an arrangement pattern 26AL shown in FIG. 14A is recognized in the first display period T1, an arrangement pattern 26BL shown in FIG. 14B is recognized in the second display period T2 and an arrangement pattern 26CL shown in FIG. 14C is recognized in the third display period T3 by the left eye 10L of the observer as the second viewpoint pictures. Accordingly, 3D images based on the first viewpoint pictures and the second viewpoint pictures are perceived in the first to third display periods T1 to T3.

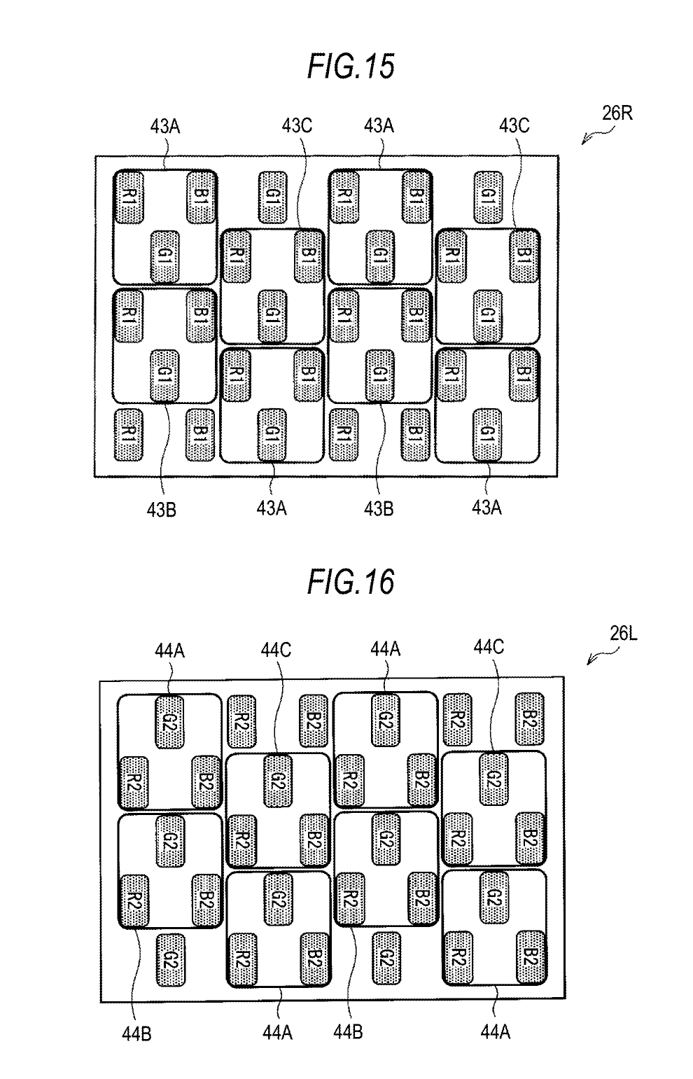

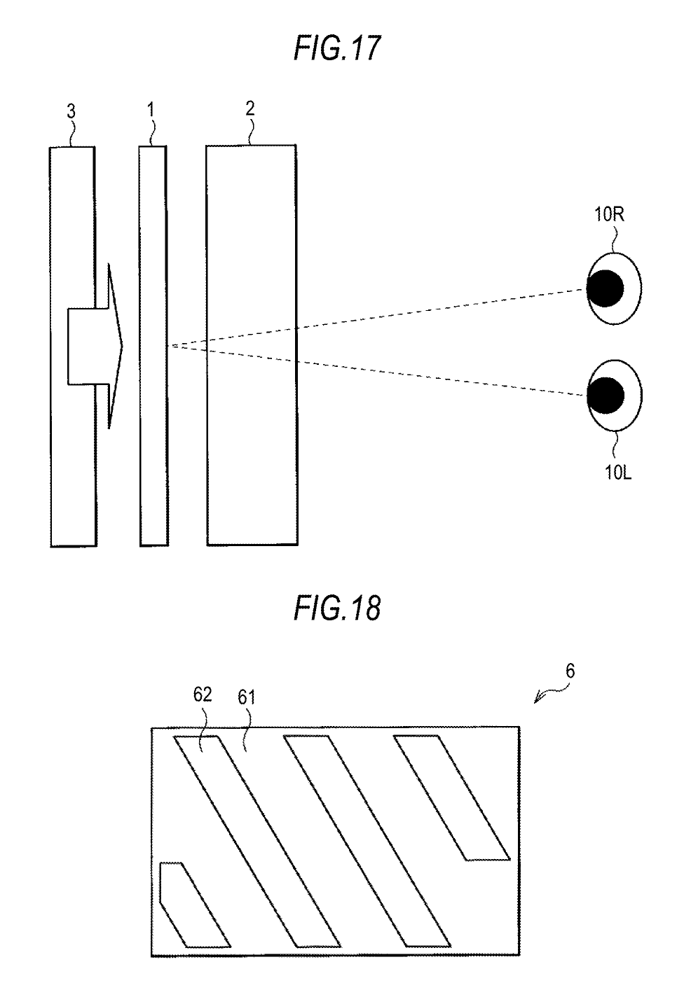

The first to third display periods T1 to T3 are extremely short periods of time also in the embodiment, therefore, all three display patterns to be displayed in the time-sharing manner are recognized by the observer as an overlapped one picture. That is, composite picture 26R obtained by combining the arrangement patterns 26AR, 26BR and 26CR of sub-pixels shown in FIGS. 13A to 13C is recognized by the observer as the first viewpoint picture obtained from the right eye 10R as shown in FIG. 15. A composite picture 26L obtained by combining the arrangement patterns 26AL, 26BL and 26CL of sub-pixels shown in FIGS. 14A to 14C is recognized as the second viewpoint picture obtained by the left eye 10L as shown in FIG. 16. As a result, a 3D image based on the first viewpoint picture and the second viewpoint pictures is perceived.

In this case, three-types of unit pixels 43A, 43B and 43C exist together in the composite picture 26R (FIG. 15) as the first viewpoint picture. For example, the unit pixel 43A is formed by combination of sub-pixels R1, G1 included in a sub-pixel row of the arrangement pattern 26AR and the sub-pixel B1 included in a sub-pixel row of the arrangement pattern 26BR. The unit pixel 43B is formed by combination of the sub-pixel B1 included in the sub-pixel row of the arrangement pattern 26AR and sub-pixels R1, G1 included in a sub-pixel row of the arrangement pattern 26CR. Furthermore, the unit pixel 43C is formed by combination of sub-pixels R1, G1 included in the sub-pixel row of the arrangement pattern 26BR and the sub-pixel B1 included in the sub-pixel row of the arrangement pattern 26CR. On the other hand, three-types of unit pixels 44A, 44B and 44C exist together in the composite picture 26L shown in FIG. 16 as the second viewpoint picture. The unit pixel 44A is formed by combination of sub-pixels G2, B2 included in a sub-pixel row of the arrangement pattern 26AL and the sub-pixel R2 included in a sub-pixel row of the arrangement pattern 26CL. The unit pixel 44B is formed by combination of the sub-pixel R2 included in a sub-pixel row of the arrangement pattern 26BL and sub-pixels G2, B2 included in the sub-pixel row of the arrangement pattern 26CL. Furthermore, the unit pixel 44C is formed by combination of sub-pixels G2, B2 included in the sub-pixel row of the arrangement pattern 26BL and the sub-pixel R2 included in the sub-pixel row of the arrangement pattern 26AL.

As described above, unit pixels in the first and the second viewpoint pictures are formed by combination of plural sub-pixels selected from three-types of display patterns 25A, 25B and 25C which are respectively displayed in the time-sharing manner also in the present embodiment, which can improve resolution.

The present disclosure has been explained by citing embodiments as the above, however, the present disclosure is not limited to the above embodiments and various modifications may occur. For example, the two-dimensional display unit is configured so that sub-pixels of the same color are arranged in the same column in the vertical direction as well as sub-pixels of different colors are arranged in order in the same row in the horizontal direction in the above embodiments, however, the present disclosure is not limited to the embodiment. That is, the two-dimensional display unit can be configured so that sub-pixels of the same color are arranged in the same row in the horizontal direction as well as sub-pixels of different colors are arranged in order in the same column in the vertical direction.

Also in the above embodiments, the case where two display patterns in which four viewpoint pictures are displayed in block on one screen are sequentially displayed in the two-dimensional display unit and the case where three display patterns in which six viewpoint pictures are displayed in block on one screen are sequentially displayed have been explained. However, the number of viewpoint pictures and the number of display patterns are not limited to the above cases and the number can be integers of 2 or more both in the viewpoint pictures and the display patterns. That is, the two-dimensional display unit according to the embodiments of the present disclosure may be the one which displays q-pieces (“q” is an integer of two or more) of display patterns respectively including p-pieces (“p” is an integer of 2 or more) of viewpoint pictures arranged cyclically in one screen and having parallax therebetween. Therefore, the variable parallax barrier as an optical separation device according to the embodiments of the present disclosure may be the one in which the arrangement state of plural light transmitting portions and plural light shielding portions can be switched corresponding to the q-pieces of display patterns to thereby separate respective display patterns displayed on the two-dimensional display units optically so as to realize stereoscopic viewing in the p-pieces of viewpoints.

The case where the unit pixel in the display unit is composed of three sub-pixels of R (red), G (green) and B (blue) has been explained in the embodiment, however, the unit pixel can be composed of sub-pixels of three or more colors (combination of R (red), G (green), B (blue) and W (white) or Y (yellow)).

Also in the embodiments, the color liquid crystal display using the backlight is shown as an example of the display device, however, the present disclosure is not limited to this. For example, a display using an organic EL element or a plasma display can be used.

The variable parallax barrier is used as the optical separation device in the above embodiments, however, the present disclosure is not limited to this. For example, a liquid crystal lens or a lenticular lens which gives optical effects to transmitted light can be used as the optical separation device. The liquid crystal lens is formed by, for example, inserting a liquid crystal layer between a pair of transparent electrode substrates arranged face to face with a given gap, which can be electrically switched to a state without lens effects and a state with lens effects according to a voltage state applied between the pair of transparent electrode substrates. When application voltage in the in-plane direction is appropriately controlled according to display patterns displayed in the display unit, the same effects as the variable parallax barrier can be obtained. The lenticular lens is formed by arranging plural cylindrical lens in one-dimensional direction. Also in the lenticular lens, the same effects as the variable parallax barrier can be obtained by changing positions in the horizontal direction of the screen in the display unit.

Also in the embodiment, the variable parallax barrier as the optical separation device, the liquid crystal display panel as the display unit and the backlight as a light source are arranged in order from the observer's side, however, it is also preferable in the embodiment of the present disclosure that the display unit (liquid crystal display panel 2), the optical separation device (switch liquid crystal panel 1) and the light source (backlight 3) are arranged in order from the observer's side. Also in this case, the same effects as the 3D display device of FIG. 1 can be obtained. As the display unit, for example, a transmissive liquid crystal display can be used.

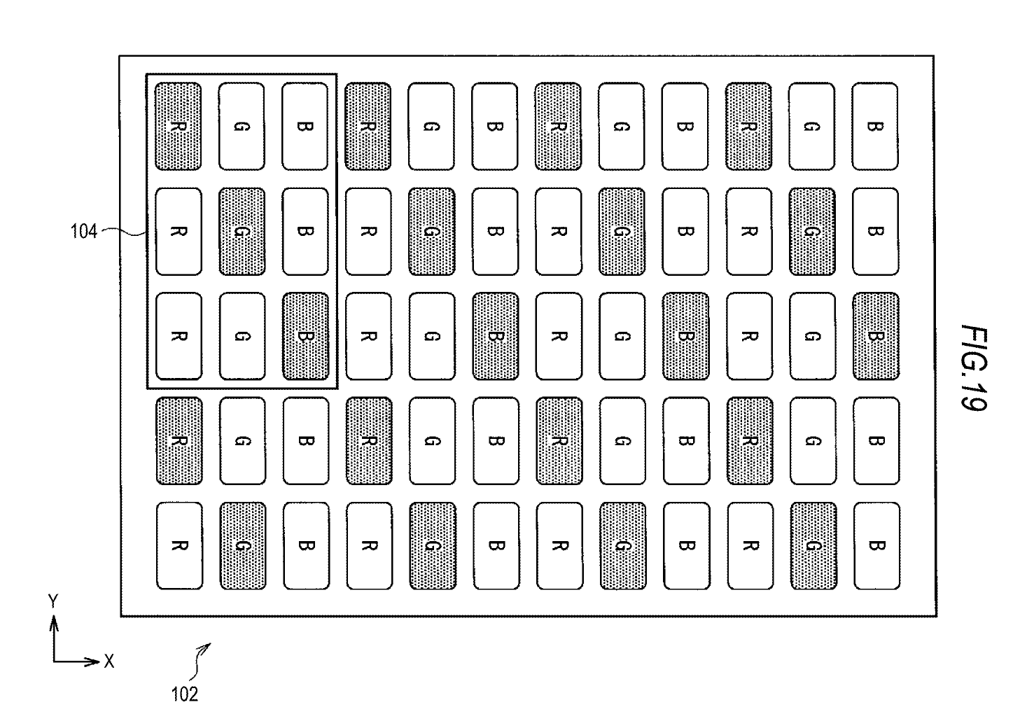

The openings in the switch liquid crystal display panel are separated to one another in the above embodiments, however, the present disclosure is not limited to this. In the embodiment of the present disclosure, plural openings performing the same operation at the same timing may be connected to one another. For example, a slit-shaped opening 62 extending in the oblique direction so as to corresponding to the sub-pixel row of the same viewpoint picture can be provided in a light shielding portion 61 as in a switch liquid crystal panel 6 shown in FIG. 18. The switch liquid crystal panel 6 includes plural pixels which are two-dimensionally arranged in the same manner as the switch liquid crystal panel land can perform switching operation of switching between the light transmitting state and the non-light transmitting state in respective pixels.

The present disclosure contains subject matter related to that disclosed in Japanese Priority Patent Application JP 2010-252241 filed in the Japan Patent Office on Nov. 10, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit sequentially displaying q-pieces (“q” is an integer of 2 or more) of display patterns respectively including p-pieces (“p” is an integer of 2 or more) of viewpoint pictures arranged cyclically in one screen and having parallax therebetween;
an optical separation device optically separating the p-pieces of viewpoint pictures respectively included in the q-pieces of display patterns displayed on the display unit,
wherein the display unit is configured so that plural sub-pixels are two-dimensionally arranged in units of r-types (“r” is an integer of 3 or more) of colors necessary for color picture display, and
one unit pixel is composed of r-pieces of sub-pixels having colors different from one another selected from the plural display patterns in respective viewpoint pictures.

2. The display device according to claim 1,
wherein the optical separation device is a variable parallax barrier including plural light transmitting portions through which light from the display unit or light toward the display unit is transmitted and plural light shielding portions shielding light from the display unit or light toward the display unit, which is configured so that an arrangement state of these plural light transmitting portions and plural light shielding portions can be switched corresponding to the q-pieces of display patterns.

3. The display device according to claim 1,
wherein the r-pieces of sub-pixels composing the one unit pixel are arranged so that respective center points are positioned at apexes of a polygon.

4. The display device according to claim 3,
wherein the one unit pixel is composed of the sub-pixels of three colors of R (red), G (green) and B (blue) selected from the plural display patterns, and the sub-pixels of two colors exist in the same row in the horizontal direction of the screen as well as the sub-pixel of the remaining one color exists in a row adjacent to the row where the sub-pixels of two colors exist.

5. The display device according to claim 3,
wherein the sub-pixels are arranged so that respective center points are positioned at apexes of an acute triangle.

6. The display device according to claim 1, wherein p/q=2,
the display unit is configured so that the sub-pixels of three colors of R (red), G (green) and B (blue) are cyclically arranged in the horizontal direction of the screen, and
the one unit pixel is composed of sub-pixels of two colors positioned closest to each other in a first row extending in the horizontal direction in the sub-pixels of three colors and the sub-pixel of the remaining one color existing in a second row adjacent to the first row and positioned between the sub-pixels of two colors in the horizontal direction of the screen.

7. A display device comprising:
a display unit displaying plural viewpoint pictures; and
an optical separation device optically separating the plural viewpoint pictures,
wherein the viewpoint pictures are displayed by being divided into plural frames, and
a unit pixel of the display unit is composed of sub-pixels in plural different frames.

8. The display device according to claim 7,
wherein the optical separation device is configured so that the light transmitting portions and the light shielding portions can be switched corresponding to frames.

9. The display device according to claim 7,
wherein the unit pixel is composed of the sub-pixels of three colors of R (red), G (green) and B (blue), and the sub-pixels of two colors among them exist in the same row in the horizontal direction of the screen as well as the sub-pixel of the remaining one color exists in a row adjacent to the row where the sub-pixels of two colors exist.

10. A display method comprising:
sequentially displaying q-pieces (“q” is an integer of or more) of display patterns on a display unit, which respectively includes p-pieces (“p” is an integer of 2 or more) of viewpoint pictures arranged cyclically in one screen and having parallax therebetween; and
optically separating the p-pieces of viewpoint pictures respectively included in the q-pieces of display patterns displayed on the display unit by using an optical separation device,
wherein the display unit configured so that plural sub-pixels are two-dimensionally arranged in units of r-types (“r” is an integer of 3 or more) of colors necessary for color picture display is used, and
one unit pixel is composed of r-pieces of sub-pixels having colors different from one another selected from the plural display patterns in respective viewpoint pictures.

11. The display method according to claim 10,
wherein a variable parallax barrier is used as the optical separation device, which includes plural light transmitting portions through which light from the display unit or light toward the display unit is transmitted and plural light shielding portions shielding light from the display unit or light toward the display unit, and which is configured so that an arrangement state of these plural light transmitting portions and plural light shielding portions can be switched corresponding to the q-pieces of display patterns.

12. A display device comprising:
a display unit sequentially displaying p-pieces (“p” is an integer of 2 or more) of viewpoint pictures in q-pieces (“q” is an integer of 2 or more) of display patterns respectively including plural arrangements of sub-pixels; and
an optical separation device optically separating the p-pieces of viewpoint pictures,
wherein one unit pixel is composed of the plural sub-pixels selected from the plural display patterns in the respective viewpoint pictures.
